(19) United States
(12) Patent Application Publication
(10) Pub. No.: US 2017/0254546 A1
(43) Pub. Date: Sep. 7, 2017

(54) APPARATUS FOR MONITORING AT LEAST ONE THERMAL CONTROL DEVICE, AND ASSOCIATED CONTROL UNIT AND CONTROL SYSTEM

(71) Applicant: BETTER WATT, LEVALLOIS PERRET (FR)

(72) Inventor: Georges GHANEM, LEVALLOIS-PERRET (FR)

(73) Assignee: BETTER WATT, LEVALLOIS PERRET (FR)

(21) Appl. No.: 15/511,920

(22) PCT Filed: Aug. 18, 2015
(86) PCT No.: PCT/FR2015/052223

§ 371 Date: Mar. 16, 2017

(30) Foreign Application Priority Data
Sep. 16, 2014 (FR) 1458744

(51) Int. Cl. F24D 19/10; G05B 19/048; F24D 13/00; G05D 23/19; F24D 3/02

(52) U.S. Cl. CPC F24D 19/1081; G05D 23/1917; G05D 23/1932; F24D 3/02; F24D 13/00; G05B 19/048; G05B 2219/2658

(57) ABSTRACT

Some embodiments are directed to an apparatus for monitoring at least one thermal control device, the device including a power supply input terminal suitable for being connected to an electric power source. The monitoring apparatus includes an electronic console that stores control instructions from the or each thermal control device. The control instructions include, for each thermal control device, at least one temperature setpoint and one energy consumption setpoint; at least one temperature sensor suitable for providing temperature data measurements, the temperature and energy consumption setpoints being determined based on parameters comprising at least said temperature data measurements; and at least one device for controlling the electric power supply of the or one of the thermal control devices, connected to the power supply input terminal of said device and suitable for controlling the electric power supply of the device based on at least the temperature and energy consumption setpoints.

### CROSS REFERENCE TO RELATED APPLICATION

This application is a National Phase filing under 35 C.F.R. §371 of and claims priority to PCT Patent Application No.: PCT/FR2015/05223, filed on Aug. 18, 2015, which claims the priority benefit under 35 U.S.C. §119 of French Application No.: 1458744, filed on Sep. 16, 2014, the contents of which are hereby incorporated in their entireties by reference.

### TECHNICAL FIELD

Some embodiments relate to an apparatus for the monitoring of at least one thermal control device in the interests of reducing its energy consumption, and to an associated control unit and control system. Some embodiments specifically relate to the optimized control of devices for the heating or management of hot water in residential buildings.

### RELATED ART

The energy consumption of devices for the heating and management of hot water accounts, on average, for over 60% of the total energy consumption of a residential building.

In order to reduce the energy consumption of these thermal control devices, and consequently their associated costs, a number of solutions have been developed.

### SUMMARY

These related solutions include control apparatuses comprising a central thermostat connected to a remote server via a communication network. The thermostat is equipped with a temperature sensor and a memory for the storage of a software application. Conventionally, the thermostat is designed to switch the heating devices in a central heating system between a “comfort” mode and an “economy” mode, or for the control thereof in relation to a plurality of setpoint temperatures, within time intervals which are predefined by a user. The thermostat is also designed, by means of the temperature sensor, for the regulation of the heating temperature in relation to a predefined setpoint temperature. A user can then connect to the network which communicates with the thermostat using a mobile communication device and, by means of the remote server, can select the setpoint temperature to be set on the thermostat. Finally, by means of its software application, a thermostat of this type is capable of learning the habits of the user, in terms of temperature settings, thereby permitting the regular optimization of heating time intervals and heating times in respect of desired temperature levels, in order to reduce the energy consumption of heating devices.

However, a control apparatus of this type does not permit the control of a decentralized heating system comprised, for example, of a series of radiators in a residential building. Another disadvantage is that the reduction in the energy consumption of heating devices is not known and, in consequence, is not optimal. Moreover, on the grounds of the centralized measurement of temperature and the occurrence of disparities in temperature within the residence, only the room in which the thermostat is located is exactly controlled to the desired setpoint temperature. This results in problems in the control of heating within the residence, such as rooms which are excessively hot or excessively cold for the residents.

Other systems for the reduction of the energy consumption of thermal control devices are proposed by operators, involving the deployment of the consumption cut-off principle. More specifically, systems of this type comprise an electronic console arranged within the residence. The electronic console is connected firstly to a communication network which is external to the residence, and secondly to the electric power supply system of the thermal control devices. Accordingly, the operator of the energy cut-off service can, by means of the communication network and the electronic console, momentarily interrupt the electric power supply to a number of high-consuming heating devices, for example in order to prevent peaks in energy consumption, or to permit the client of the service to enjoy the optimum exploitation of reduced tariff time intervals.

A disadvantage of systems of this type is their inability to regulate heating in relation to a setpoint temperature.

A related art solution for overcoming this disadvantage is proposed in document EP 2953947, which describes an optimized control module for thermal control devices. The control module comprises means for the transmission, to the thermal control devices to which it is connected, of a signal for the activation and/or deactivation of the devices, means of determination which are designed to determine, for each device to be regulated, an activation time for the device as a function of an estimated temperature setpoint value, and means for the measurement of temperature. In the invention disclosed by this document, the energy cut-off time dictated by the control module is determined as a function of a temperature interval based around the selected setpoint temperature, in order to offset the cut-off in terms of the comfort of the user.

However, the reduction in the energy consumption of heating devices achieved by a control module of this type is not known and, in consequence, is not optimal, specifically on the grounds that this reduction is executed from the viewpoint of the service operator. Moreover, a control method deployed using a control module of this type, whilst intended to ensure an acceptable level of comfort within the residence can, by very dint of the energy cut-off principle, result in situations in which the ultimate thermal comfort of the user is compromised.

The invention described hereinafter is intended to rectify all or part of the disadvantages of the prior art, specifically by the disclosure of an apparatus for the monitoring of at least one thermal control device for the purposes of the further reduction of the energy consumption of the, or of each thermal control device, whilst simultaneously permitting the control of centralized and decentralized thermal control systems, without impairing the ultimate thermal comfort of the user.

To this end, the object of the invention is an apparatus for monitoring at least one thermal control device, wherein said device is arranged within premises and comprises an electric power supply input terminal which is suitable for connection to an electric power supply source, said apparatus comprising:
an electronic console arranged within the premises, wherein said electronic console stores instructions for the control of the, or of each thermal control device, wherein said control instructions comprise, for each thermal control device, at least one temperature setpoint and one energy consumption setpoint,
at least one temperature sensor arranged within the premises, and designed to communicate with the electronic console via a first data link, wherein the or each sensor is designed to deliver temperature measurement data, and wherein temperature and energy consumption setpoints are determined as a function of parameters which shall comprise at least said temperature measurement data,
at least one electric power supply control device for the thermal control device(s), connected to the electric power supply input terminal of said device, wherein the or each control device is designed to communicate with the electronic console via a second data link, and to deploy the electric power supply command for the device as a function of at least the temperature and energy consumption setpoints transmitted by the electronic console, and
at least one measuring element for a variable which is representative of the energy consumption of the or one of the thermal control device(s), wherein the or each measuring element is arranged within the premises and is designed to communicate with the electronic console via a fourth data link, and wherein the temperature and energy consumption setpoints are determined as a function of parameters which shall include, moreover, measurement data for said variable.

The energy consumption setpoint corresponds to an energy quota which is allocated to the control device over a given period of time. As the control instructions for each thermal control device include at least one temperature setpoint and one energy consumption setpoint, the or each control device permits the delivery of the electric power supply to the associated thermal control device, in an endeavor to achieve the setpoint temperature, for such time as the allotted energy consumption quota is not exceeded. The thermal comfort of the user is thus regulated on a continuous basis as a function of energy consumption, and comfort time settings are accurately adjusted to the strict degree necessary. This permits the minimization of overall energy consumption, without impairing the ultimate thermal comfort of the user. Moreover, as a result of the connection of each control device to the electric power supply of the associated device, the control apparatus according to the invention is advantageously compatible with all existing technologies employed in thermal control devices. Conversely, monitoring systems from the prior art employ a standard wired system for the control devices, thus rendering them specific to particular technologies. Advantageously, the control apparatus according to the invention permits the control of both centralized and decentralized systems.

Moreover, the presence of at least one measuring element for a variable which is representative of energy consumption within the control apparatus advantageously permits the improvement of the accuracy of the calculation of temperature and energy consumption setpoints.

Advantageously, the or each control device is designed to communicate with the temperature sensor(s) via a third data link, wherein the or each control device is designed to control the electric power supply to the associated thermal control device as a function of at least the temperature and energy consumption setpoints and the measured temperature data delivered by said temperature sensor, for the regulation of temperature within the premises.

Advantageously, the electronic console comprises a microcontroller and a memory connected to the microcontroller, wherein the memory stores command instructions for the or each thermal control device, and wherein the microcontroller is designed for the deployment of an application comprising at least one module for the management of external and internal communications on the apparatus, a module for the management of an autonomous mode of the electronic console, a module for the management of commands, and a data storage module.

Advantageously, the control apparatus moreover comprises at least one acoustic sensor arranged within the premises and which is designed to communicate with the electronic console via a fifth data link, wherein the or each acoustic sensor is designed to deliver measured acoustic data, and wherein the temperature and energy consumption setpoints are determined as a function of parameters which moreover comprise said measured acoustic data.

According to a further aspect, another object of the invention is a control unit for at least one thermal control device, wherein said device is arranged within premises and comprises an electric power supply input terminal which is suitable for connection to an electric power supply source, wherein the unit comprises an apparatus for the monitoring of the or each thermal control device, as described heretofore, and a server which is connected to the control apparatus via a communication network.

Advantageously, the electronic console is suitable for connection to the communication network and is suitable for the transmission to the server of at least the temperature data measured by the or by each temperature sensor, wherein the server is designed to generate command instructions for the or each thermal control device and to transmit said command instructions to the electronic console.

Advantageously, the server comprises at least one processor and at least one memory connected to the processor, wherein the memory stores an application, said application being designed, upon the deployment thereof by said at least one processor, to generate command instructions for the or each thermal control device as a function of parameters which shall comprise at least said measured temperature data.

Advantageously, the application comprises a zoning module which is designed to divide the premises into a number of predetermined zones, in that the control apparatus comprises a plurality of temperature sensors, wherein each predetermined zone is equipped with at least one of said temperature sensors, and in that the memory of the server incorporates a decision-making table, wherein the inputs of said decision-making table are the temperature-related time scheduling data for each predetermined zone, and wherein the output of said decision-making table is a command signal for the priority execution of the time schedule in one of the predetermined zones, wherein the command signal for priority execution is designed for transmission to the control apparatus via the communication network.

Advantageously, the server is designed to generate a signal for the detection of the presence of a user within the premises, as a function of at least the measured acoustic data values, and to generate command instructions for the or each thermal control device as a function of parameters which shall moreover comprise said presence detection signal.

According to a further aspect, another object of the invention is a computer program product, which is downloadable from a communication network and/or embodied in a computer-readable medium and/or executable by a processor, comprising program instructions, wherein said program instructions constitute the application of the server for the control unit as described heretofore, where the program product is run on said server.

Advantageously, the computer program product comprises a calculation module which is designed to generate command instructions for the or each thermal control device as a function of parameters which shall include, in addition to the temperature data measured by the or each temperature sensor, indicative data for the restriction of energy consumption, climatic data and representative data for technical characteristics of the premises, wherein the climatic data and representative data for technical characteristics of the premises shall be sourced from at least one database which is connected to the server.

Advantageously, the calculation module is designed to generate, for each thermal control device, a first estimated data element which is representative of the energy consumption of said device, and a second estimated data element which is representative of the energy saving realized, wherein said first and second estimated data elements are obtained at least from the temperature data measured by the or each temperature sensor, climatic data, and data which are representative of technical characteristics of the premises, and the calculation module is designed to generate, for each thermal control device, a calibrated data element which is representative of the energy saving realized, wherein the value of the calibrated data element corresponds to the value of the second estimated data element, calibrated in relation to the margin between the value of the first estimated data element and the value of the measured data for the variable which is representative of energy consumption.

According to a further aspect, another object of the invention is a system for the control of at least one thermal control device, wherein the device is arranged within premises and comprises an electric power supply input terminal which is suitable for connection to an electric power supply source, wherein the system comprises a control unit for the or each thermal control device, as described heretofore, and at least one computer which is connected to the control unit via a communication network.

Advantageously, the computer is provided with data acquisition means, and the server is designed to generate command instructions for the or each thermal control device as a function of parameters moreover comprising the data acquired by the computer, wherein the data acquired by the computer comprise at least one indicative data element for a restriction on energy consumption.

Advantageously, the data acquisition means comprise a user interface and an application stored in a computer memory, wherein the application comprises a module for the acquisition of data which are representative of interactions of a user with the premises and/or a module for the acquisition of data which are representative of the thermal sensations of a user and/or a geolocation module, and in that the server is designed to generate a signal for the detection of the presence of a user within the premises, as a function of said acquired and/or geolocated data, and to generate command instructions for the or each thermal control device as a function of parameters which shall moreover comprise said presence detection signal.

According to a further aspect, another object of the invention is a computer program product, which is downloadable from a communication network and/or embodied in a computer-readable medium and/or executable by a processor, comprising program instructions, wherein said program instructions constitute the application for the data acquisition means of the computer of the control system as described heretofore, where the program product is run on said computer.

### BRIEF DESCRIPTION OF THE FIGURES

Further characteristics and advantages of the invention will emerge from the following description, which is provided for exemplary purposes only, with reference to the following:

FIG. 1 shows a schematic representation of a system for the control of two thermal control devices according to a first form of embodiment of the invention, wherein the system comprises a control unit equipped with a server and an apparatus for the monitoring of each device, and wherein the control apparatus comprises an electronic console, two acoustic sensors, and two devices for the control of the electric power supply to a thermal control device;

FIG. 2 shows a schematic representation of an application stored in a memory of the electronic console shown in FIG. 1;

FIG. 3 shows a schematic representation of one of the control devices from FIG. 1, connected to an electric power supply input terminal of one of the thermal control devices;

FIG. 4 shows a schematic representation of an application stored in a memory of each electric power supply control device shown in FIG. 1;

FIG. 5 shows a schematic representation of one of the acoustic sensors shown in FIG. 1;

FIG. 6 shows a schematic representation of an application stored in the memory of the server shown in FIG. 1;

FIG. 7 shows an analogous representation to that shown in FIG. 1, according to one variant of embodiment of the invention;

FIG. 8 shows an organigram representing a method for the installation of the control apparatus shown in FIG. 1.

### DETAILED DESCRIPTION OF ONE FORM OF EMBODIMENT

In the description hereinafter, the term “thermal control device” is to be understood as any device which is capable of acting on the temperature of a location, a room in a building or a facility, either by means of a heating mode or a cooling mode. Such a device may be dedicated to one of these modes, for example a boiler or a radiator for a heating mode or an air-conditioning system for a cooling mode, or may be capable of operating in either of these two modes, as in the case of a reversible heat pump, for example.

The term “computer” is likewise to be understood as any electronic device equipped with means for the calculation of data and means for the storage of data including, for example, a desktop computer, a portable computer, a wireless communication device such as a smartphone, or a digital tablet computer, whereby the above list is not exhaustive.

The “time scheduling” of a zone is moreover to be understood as a list of time slots staggered over a predetermined time period, for example a week, during which the zone is required to assume a “comfort” mode for the user.

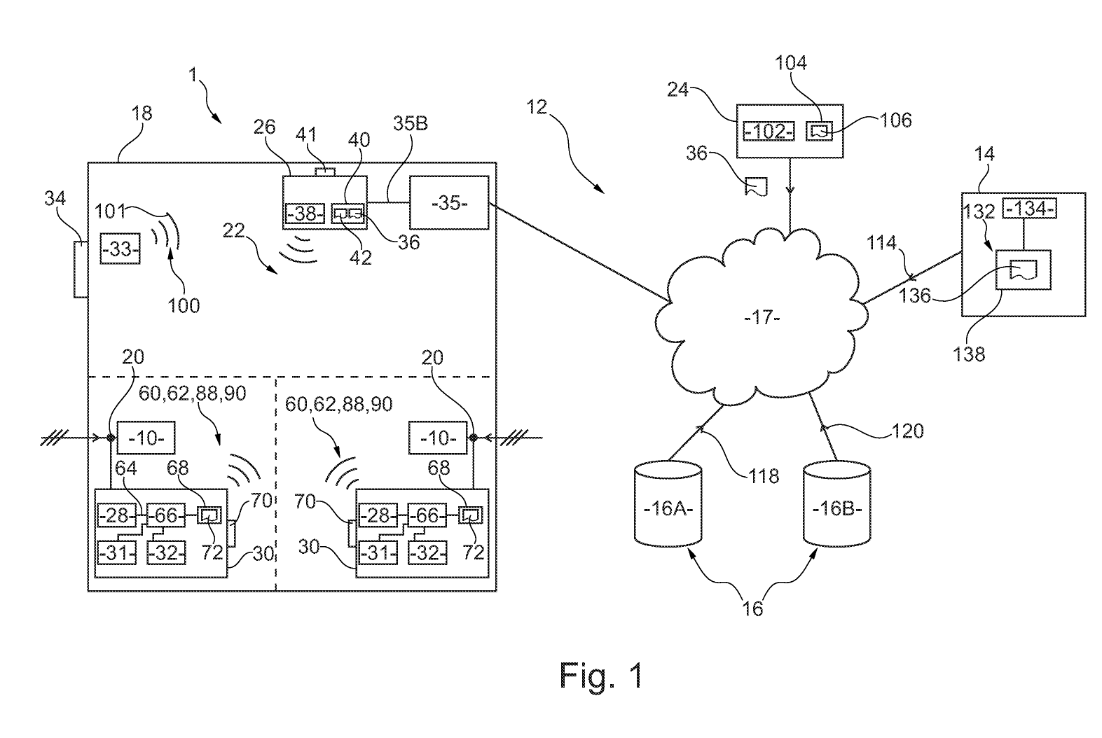

According to a first aspect of the invention represented in FIG. 1, a system 1 for the monitoring of at least one thermal control device 10 comprises a unit 12 for the control of the or each thermal control device 10 and at least one computer 14. In the exemplary embodiment shown in FIG. 1, only two thermal control devices 10 and one computer 14 are represented, for reasons of clarity. According to one mode of embodiment of the invention, the monitoring system 1 is connected to at least one database 16, via a communication network 17. In the illustrative example shown in FIG. 1, the monitoring system 1 is connected to a first database 16A and to a second database 16B.

Each thermal control device 10 is arranged within premises 18. By way of a non-limiting example, the premises 18 is, for example, a residential building.

The first database 16A stores, for example, climatic data or seasonal temperature data pertaining to at least the geographical zone within which the premises 18 is located.

The second database 16B stores, for example, representative data for technical characteristics of the premises, including at least the technical characteristics which are relevant to the premises 18. By way of a non-limiting example, the technical characteristics of premises include, for example, the type of construction and insulation materials used, or the thickness of the constituent layers of the walls of the premises.

The communication network 17 is equipped with a private or wide-area communication infrastructure permitting the connection of, or access, to communication facilities of the server and/or database type. Conventionally, the communication infrastructure is configured as a wireless network or a wired network, or as a network comprised of a wireless portion and a wired portion. In one specific form of embodiment, the communication network 17 is designed as a network of the Internet type.

Each thermal control device 10 comprises an electric power supply input terminal 20 which is suitable for connection to an electric power supply source. The electric power supply source is not represented in the figures, for reasons of clarity, but is constituted, for example, by a conventional two-phase electric grid system.

In one form of embodiment of the invention illustrated in FIG. 1, each thermal control device 10 is, for example, an electric radiator. According to this form of embodiment, the combination of thermal control devices 10 thus constitutes a decentralized heating system, wherein each device 10, for example, is installed in one room of the premises 18.

The control unit 12 comprises an apparatus 22 for the monitoring of the or each thermal control device 10, and a server 24. The control apparatus 22 is connected to the server 24 via the communication network 17.

The control apparatus 22 is arranged within the premises 18, and comprises an electronic console 26, at least one temperature sensor 28, at least one device 30 for the control of the electric power supply to the or one of the thermal control device(s) 10, and at least one element 31 for the measurement of a variable which is representative of energy consumption by the or by one of the thermal control device(s) 10. In the exemplary embodiment shown in FIG. 1, the control apparatus 22 comprises two temperature sensors 28, two control devices 30, and two measuring elements 31. According to the preferred form of embodiment illustrated in FIG. 1, the control apparatus 22 moreover comprises at least one acoustic sensor 32 and at least one device 33 for the detection of the opening of an opening element 34. By way of a non-limiting example, the control apparatus 22 comprises, for example, two acoustic sensors 32 and a device 33 for the detection of the opening of the opening element 34, as represented in FIG. 1.

The electronic console 26 is arranged within the premises 18 and is connected to the server 24 via the communication network 17. According to a specific form of embodiment illustrated in FIG. 1, the electronic console 26 is, for example, connected to the communication network 17 via a terminal box 35 which provides access to a high-capacity data communication link incorporated in the network 17, for example a high-capacity internet connection. According to this form of embodiment, an Ethernet cable 35B connects, for example, the electronic console 26 to an Ethernet port on the terminal box 35. The electronic console 26 will then be capable of exchanging data on the communication network 17, regardless of the type of terminal box 35 employed. This facilitates the installation of the electronic console 26 within the premises 18.

The electronic console 26 stores command instructions 36 for the or each thermal control device 10. Preferably, the electronic console 26 is equipped with a microcontroller 38 and a memory 40 connected to the microcontroller 38, wherein the memory 40 stores the command instructions 36. In one specific form of embodiment of the invention, the electronic console 26 is moreover equipped with a radio-tag 41.

The command instructions 36 comprise, for each thermal control device 10, at least one temperature setpoint and one energy consumption setpoint.

The temperature setpoint may be a service temperature setpoint for the thermal control device 10, or a temperature setpoint for the ambient air in a room of the premises 18 which is thermally controlled by the thermal control device 10. The temperature setpoint assumes the form of data for the time scheduling of temperature on the thermal control device 10. The energy consumption setpoint corresponds to an energy quota which is allotted to the control device 30, associated with a given period of time. The energy quota preferably corresponds to a finite value and is, for example, expressed as the interval between two discrete values, but can also be expressed in the form of an “infinite” value, as detailed hereinafter. An “infinite” value is understood as a value which is very substantially superior to the maximum finite value which can be assumed by the energy quota, typically a value exceeding 100 times this maximum finite value.

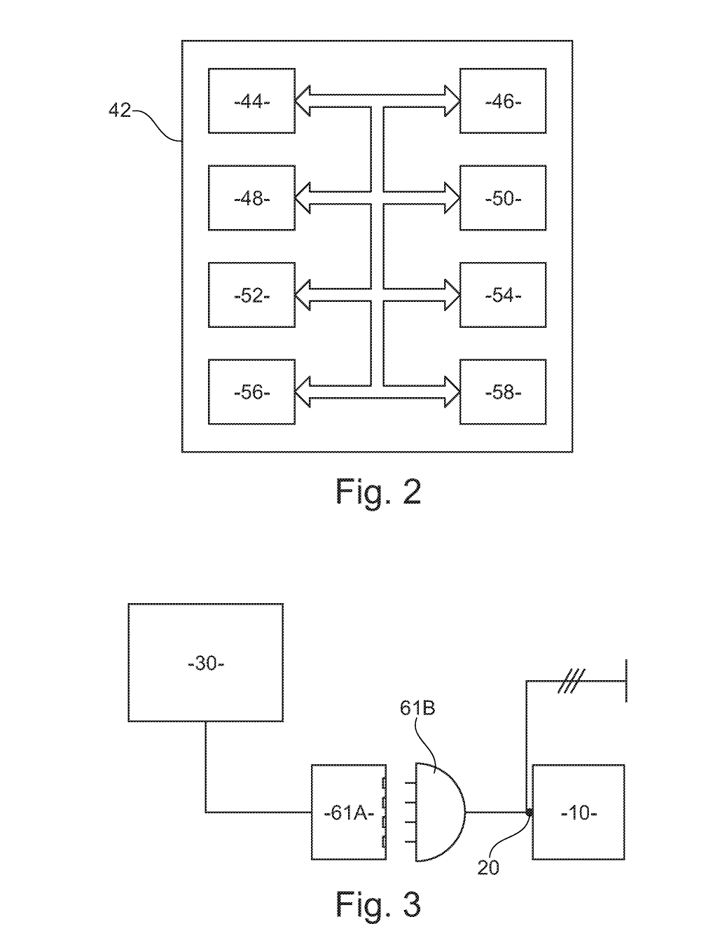

Preferably, the memory 40 also stores an application 42. As represented in FIG. 2, the application 42 comprises at least one management module 44 for external and internal communications on the apparatus 22, a management module 46 for an autonomous mode on the electronic console 26, a management module 48 for commands, and a data storage module 50. The microcontroller 38 is appropriate for the deployment of the application 42.

In a specific form of embodiment of the invention, the application 42 moreover comprises a management module 52 for a derogation mode on the electronic console 26, a module 54 for the updating of the application 42 and/or of each control device 30, a module 56 for the identification of outages and a management module 58 for pairing. According to this form of embodiment, the electronic console 26 moreover comprises means for the acquisition of a derogation instruction delivered by a user such as, for example, an external control button.

The external and internal communication management module 44 is designed to receive data originating from the server 24 or from one of the elements of the control apparatus 22, and to transmit data for the attention of the server 24 or one of the elements of the control apparatus 22. The transmission of data from the module 44 of the electronic console 26 to the server 24 may be executed, for example, on a regular basis, or may be triggered further to the verification of at least one predetermined condition.

The autonomous mode management module 46 is designed to transmit to the storage module 50, for storage in the memory 40, data for the time scheduling of temperature of the thermal control devices 10 and data on the energy quota allotted to the devices 10. The autonomous mode management module 46 is moreover designed to transmit, via the communication module 44, commands for the execution of time scheduling to at least one control device 30. This module 46 permits the autonomous operation of the control apparatus 22 according to the invention.

The command management module 48 is designed to transmit, via the communication module 44, commands for the interruption of the power supply and/or regulating commands to at least one control device 30. The command management module 48 is moreover designed to repeat, via the communication module 44, the transmission of commands until such time as confirmation of the execution of the commands by the control device(s) 30 concerned is obtained.

The derogation mode management module 52 is designed, further to the reception of a derogation command signal transmitted by the acquisition means on the console 26, to generate a command signal for the start-up of all the thermal control devices 10 for a predetermined duration. The derogation mode management module 52 is moreover designed to transmit, via the communication module 44, the start-up command signal to all the associated control devices 30, and to transmit a message indicative of the execution of the command to the server 24. This module 52 permits the operation of the control system 22 in a manual mode.

The updating module 54 is designed to execute an update command on the application 42, received by the communication module 44, and to transmit, via the communication module 44, update commands to at least one control device 30. In a specific form of embodiment, the updating module 54 is moreover designed to transmit to the storage module 50, for storage in the memory 40, the command received for the updating of the application 42, and to execute this command further to the restarting of the electronic consoler 26. The updating module 54 can also transmit, via the communication module 44, confirmation of the incorporation of the or of each update to the server 24. The updating module 54 permits, for example, the deployment of new functionalities and the correction of any bugs detected.

The outage identification module 56 is designed to deploy an algorithm for the diagnostic analysis of the internal or external communication links to the control apparatus 22, to verify the start-up of the or each control device 30, and to verify the correct operation of the or each temperature sensor 28 and of the or each measuring element 31. The outage identification module 56 permits the identification of internal or external malfunctions on the control apparatus 22.

The pairing management module 58 comprises a pairing table. The pairing table associates a list of identifiers for the control devices 30 with predetermined geographical zones of the premises 18 such as, for example, the rooms of the premises 18. Each identifier for a control device 30 is, for example, the serial number of said device 30.

The radio-tag 41 is, for example, a 1D bar code or a 2D matrix code of the QR code type. The radio-tag 41 permits the storage of an identifier which is specific to the electronic console 26, of the serial number type, which can be employed by a reader device for the pairing of the console 26 with the premises 18.

Each temperature sensor 28 is arranged within the premises 18, and is designed to communicate with the electronic console 26 via a first data link 60. Each temperature sensor 28 is designed to provide temperature measurement data and to transmit said data on the first data link 60. The electronic console 26 is designed to transmit to the server 24 at least the temperature data measured by each temperature sensor 28. The temperature and energy consumption setpoints are determined as a function of parameters which shall at least comprise the temperature data measured by the or each temperature sensor 28.

Each first data link 60 is a wired link or a wireless link.

Each control device 30 is arranged within the premises 18 and is connected to the electric power supply input terminal 20 of one of the thermal control devices 10. In the exemplary embodiment shown in FIG. 3, each control device 30 is equipped with a female connector 61A which is designed to accommodate a male plug 61B connected to the electric power supply input terminal 20 of one of the thermal control devices 10. This facilitates the installation of each control device 30 without the necessity, for example, of having to form a cavity in one of the walls of the premises 18. Moreover, this advantageously permits the removal and replacement of each control device 30 in a simple manner, and ensures the accessibility thereof to any user. According to this form of embodiment, each control device 30 is preferably arranged below the associated thermal control device 10. Preferably, each control device 30 is moreover provided with means of attachment to a wall of the premises 18 such as, for example, self-adhesive strips, in order to further facilitate the installation of the control device 30.

Each control device 30 is designed to communicate with the electronic console 26 via a second data link 62, and to deploy the electric power supply command on the associated device 10 as a function of at least the temperature and energy consumption setpoints transmitted by the electronic console 26. In the exemplary embodiment shown in FIGS. 1 and 3, each control device 30 is, for example, equipped with a relay which is connected to the female connector 61A, wherein the closing of the relay causes the closing of the electric power supply circuit of the associated device 10.

Each second data link 62 is a wired link or a wireless link.

According to a preferred form of embodiment, each control device 30 is designed to communicate with one of the temperature sensors 28 via a third data link 64. According to this preferred form of embodiment, each control device 30 is designed to control the electric power supply of the thermal control device 10 to which it is connected as a function of at least the temperature and energy consumption setpoints and the measured temperature data delivered by the temperature sensor 28, in order to regulate the temperature within the premises 18. Advantageously, this externally-controlled temperature regulation permits the achievement, on each control device 30, of an independently-modifiable temperature setpoint, with no requirement for any manual intervention by a user on the associated thermal control device 10. In the exemplary embodiment shown in FIG. 1, each temperature sensor 28 is arranged within a control device 30, and the third data link 64 is a wired link, which is internal to the control device 30. Moreover, in this exemplary embodiment shown in FIG. 1, the first and second data links 60, 62 are combined, and each control device 30 is designed to control the electric power supply of the thermal control device 10 to which it is connected by the emission of a command signal of the “on-off sawtooth wave” type or a command signal of the command signal of the “on-off fixed threshold” type. The fact that each temperature sensor 28, arranged within a control device 30, is positioned below the associated thermal control device 10 permits the measurement of the lowest temperature in the room, avoiding the thermal flux originating directly from said device 10.

Preferably, each control device 30 is equipped with a microcontroller 66, and with a memory 68 connected to the microcontroller 66. In a particular form of embodiment of the invention, each control device 30 is moreover equipped with a radio-tag 70. In the exemplary embodiment shown in FIG. 1, each control device 30 moreover comprises one of the measuring elements 31 and one of the acoustic sensors 32.

The microcontroller 66 is connected to the temperature sensor 28, to the measuring element 31 and to the acoustic sensor 32.

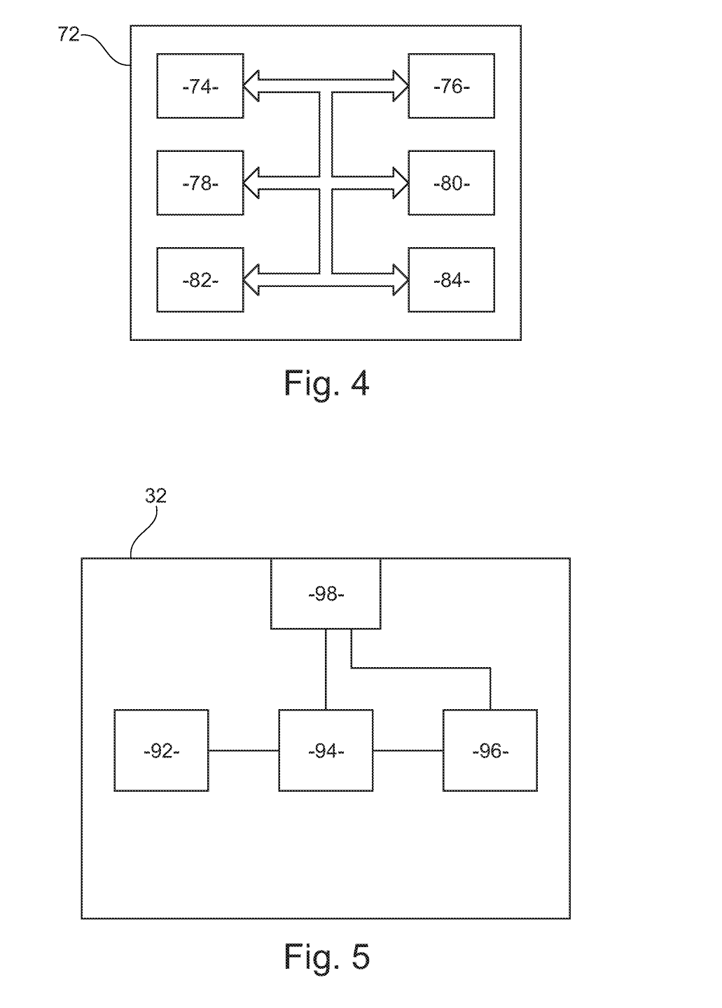

The memory 68 stores an application 72 which is designed for deployment by the microcontroller 66. As represented in FIG. 4, the application 72 comprises at least one communication management module 74, one command management module 76, and one data management module 78.

In a specific form of embodiment of the invention, the application 72 moreover comprises a module 80 for the management of the configuration of the control device 30, a module 82 for the updating of the application 72 and a module 84 for the identification of outages.

The communication management module 74 is designed to receive data originating from the console 26 and to transmit data for the attention of the console 26, using a conventional communication protocol. Specifically, the communication module 74 is designed to receive data delivered by the temperature sensor 28, the measuring element 31 and the acoustic sensor 32, and to simultaneously transmit said data to the console 26, via the second data link 62.

The command management module 76 is designed to receive and execute commands for the interruption of the electric power supply and/or regulating commands transmitted to the communication module 74. To this end, the command management module 76 is designed to deploy an algorithm which is capable of regulating the temperature on the associated thermal control device 10 by the integration of two restrictions: a priority restriction, provided by the energy consumption setpoint, and a secondary restriction provided by the temperature setpoint. Accordingly, the algorithm continuously monitors the priority restriction, and compares a measured temperature delivered by the temperature sensor with the setpoint temperature, in order to permit the closest possible tracking of the secondary restriction. In practice, the algorithm tracks the secondary restriction for such time as the energy quota delivered by the energy consumption setpoint is not consumed by the associated thermal control device 10. As a variant, the measured temperature is delivered by another temperature sensor 28, wherein this specifically permits the improvement of reliability in the event of an outage. In a preferred form of embodiment, the command management module 76 is designed to execute commands in real time.

The data management module 78 is designed to execute calculations using the data collected by the communication module 74. The data management module 78 is designed moreover to save, in the memory 68, at least the most recent item of data collected. This saving function is, for example, executed in a regular manner in the memory 68.

The configuration management module 80 is designed to permit the remote configuration and/or verification, via the communication module 74, of certain parameters. Parameters of this type include, for example, parameters relating to the associated second data link 62, or an identifier for the control device 30 such as, for example, a serial number.

The updating module 82 is designed to execute a command for the updating of the application 72 received by the communication module 74. The updating module 82 can also transmit, via the communication module 74, confirmation of the incorporation of the or each update to the electronic console 26. The updating module 82 permits, for example, the deployment of new functionalities and the correction of any bugs detected.

The outage identification module 84 is designed to deploy an algorithm which is capable of executing a diagnostic analysis of the second data links 62, verifying the start-up and/or status of the temperature sensor 28 and of the measuring element 31, verifying the correct operation of the control device 30, and verifying the available memory space in the memory 40.

The radio-tag 70 is, for example, a 1D bar code or a 2D matrix code of the QR code type. The radio-tag 70 permits the storage of an identifier which is specific to the control device 30, of the serial number type, which can be employed by a reader device for the pairing of the control device 30 with the electronic console 26. Further to the pairing thereof with the electronic console 26, the control devices 30 are able to undertake the automatic transmission, via each communication module 74, of their respective identifiers to the console 26, in order to construct a local network of control devices. This local network employs the second bidirectional data links 62 and is, for example, configured as a star network, which is automatically reconfigurable in the event of malfunctions and/or outages.

Each element 31 for measuring a representative variable of energy consumption is arranged within the premises 18, and is designed to communicate with the electronic console 26 via a fourth data link 88. Each measuring element 31 is designed to transmit measured data for the variable on the fourth data link 88. The electronic console 26 is moreover designed for the transmission to the server 24 of measured data for the variable delivered by each measuring element 31. The temperature and energy consumption setpoints are determined as a function of parameters which moreover comprise measured data for the variable delivered by the or each measuring element 31. The presence of at least one measuring element 31 in the control apparatus 22 specifically permits the improvement of the accuracy of calculation of the temperature and energy consumption setpoints.

Each data link 88 is a wired link or a wireless link.

In a specific exemplary embodiment illustrated in FIG. 1, each measuring element 31 is an electric current sensor connected to the electric power supply input terminal 20 of one of the thermal control device(s) 10. According to this exemplary embodiment, each current sensor 31 is arranged within one of the control devices 30, and the second and fourth data links 62, 88 are combined. In an unrepresented variant, each current sensor 31 is arranged on the exterior of a control device 30, whilst still being connected to the electric power supply input terminal 20 of one of the thermal control device(s) 10. Each current sensor 31 is designed to measure a variable relating to the electric current consumed by the associated thermal control device 10 such as, for example, electrical intensity.

Each acoustic sensor 32 is arranged within the premises 18, and is designed to communicate with the electronic console 26 via a fifth data link 90. Each acoustic sensor 32 is designed to deliver measured acoustic data, and to transmit these data on the fifth data link 90. The electronic console 26 is moreover designed to transmit to the server 24 the acoustic data measured by each acoustic sensor 32. The temperature and energy consumption setpoints are determined as a function of parameters which, moreover, comprise the data measured by the or each acoustic sensor 32. The presence of at least one acoustic sensor 32 within the control apparatus 22 permits the detection of one or more human voice(s) within the premises 18, and the deduction therefrom of the presence of a user, thus permitting the improvement of the accuracy of calculation of the command instructions 36.

In the exemplary embodiment shown in FIG. 1, each acoustic sensor 32 is arranged within one of the control devices 30, and the second and fifth data links 62, 90 are combined. In an unrepresented variant, each acoustic sensor 32 is arranged on the exterior of a control device 30.

In a specific exemplary embodiment illustrated in FIG. 5, each acoustic sensor 32 comprises a microphone 92, an amplifier 94, a filter 96 and a transmitter 98.

The output of the microphone 92 is connected to the input of the amplifier 94. The microphone 92 has a bandwidth substantially within the range of 100 Hz to 3500 Hz. The microphone 92 is, for example, a condenser microphone.

The output of the amplifier 94 is connected to the input of the filter 96 and to the input of the transmitter 98. The amplifier 94 is, for example, a staged amplifier.

The output of the filter 96 is connected to the input of the transmitter 98. The filter 96 is, for example, a band-pass filter having a bandwidth substantially within the range of 100 Hz to 250 Hz.

The device 33 for the detection of the opening of the opening element 34 is arranged within the premises 18 and is designed to communicate with the electronic console 26 via a sixth data link 100. The detection device 33 is designed to transmit a signal 101 for the detection of the opening of the opening element 34 on the sixth data link 100.

An opening element 34 is understood as a door or a window, specifically where the latter opens onto the exterior of the premises 18.

The sixth data link 100 is a wired link or a wireless link.

In a preferred form of embodiment, the first data links 60, the second data links 62, and the sixth data link 100 are each configured as a wireless radioelectric link, for example a radioelectric link in compliance with IEEE standard 802.15.4 (Zigbee protocol), or a radioelectric link employing a frequency band which substantially encompasses a central frequency equal to 868 MHz.

The server 24 is designed to generate command instructions 36 for the or each thermal control device 10 as a function of parameters which shall at least comprise the temperature data measured by the or each temperature sensor 28. The server 24 is moreover designed to transmit, via the communication network 17, command instructions 36 to the electronic console 26. This transmission of command instructions 36 by the server 24 can be executed, for example, in real time, immediately upon the generation by the server 24 of new command instructions 36. In a particular form of embodiment of the invention, the server 24 is moreover designed to generate the pairing table for the association of a list of identifiers for control devices 30 with predetermined geographical zones in the premises 18, and to transmit this pairing table to the electronic console 26.

According to a particular form of embodiment of the invention, the server 24 comprises at least one processor 102 and at least one memory 104. In the exemplary embodiment shown in FIG. 1, the server 24 comprises a single processor 102 and a single memory 104.

The memory 104 is connected to the processor 102 and stores an application 106 which is designed for deployment by the processor 102. The application 106 is designed, upon the deployment thereof by the processor 102 to generate command instructions 36 for the or each thermal control device 10 as a function of parameters which shall at least comprise the temperature data measured by the or each temperature sensor 28.

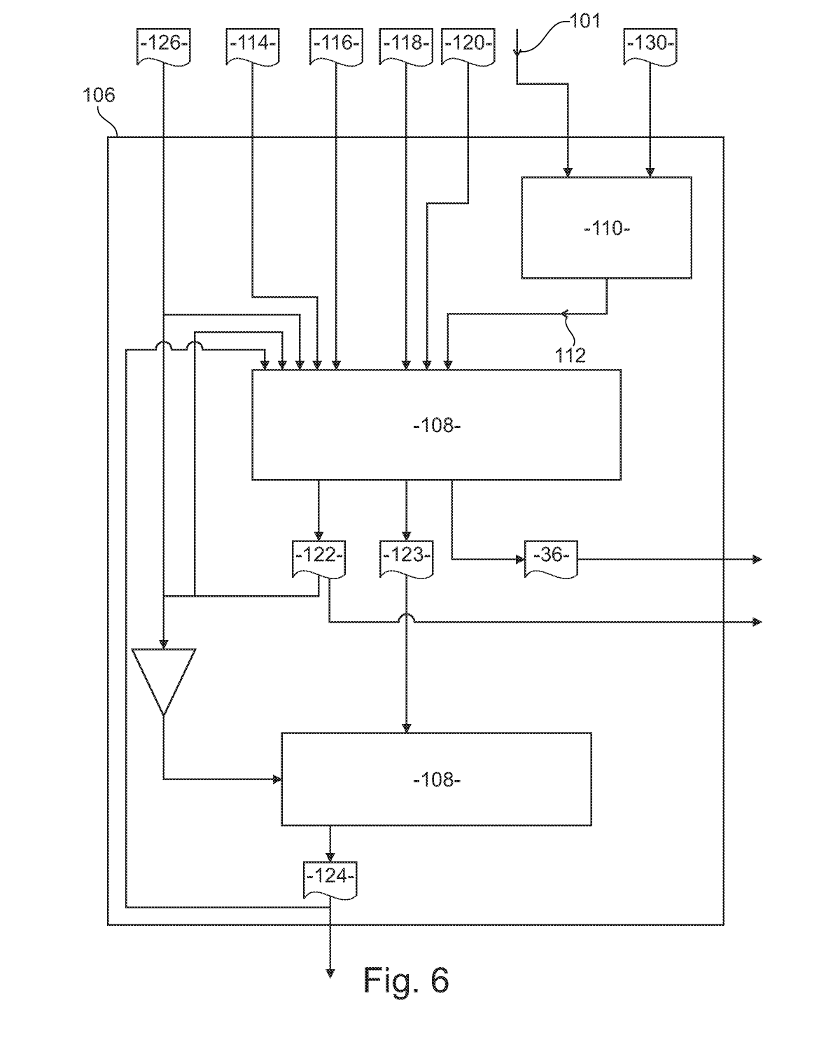

In a particular form of embodiment illustrated in FIG. 6, the application 106 comprises a calculation module 108 and a module 110 for the generation of a signal 112 for the detection of the presence of a user within the premises 18. According to this particular form of embodiment, the server 24 is designed to generate the signal 112 for the detection of the presence of a user within the premises 18 as a function of at least the acoustic data measured by each acoustic sensor 32, as detailed hereinafter.

In the exemplary embodiment shown in FIGS. 1 and 6, the calculation module 108 is designed to generate command instructions 36 for the or each thermal control device 10 as a function of parameters which shall include the following:
an indicative data element 114 for a restriction in energy consumption,
temperature data 116 measured by each temperature sensor 28,
seasonal climatic or temperature data 118 stored in the first database 16A,
representative data 120 for technical characteristics of premises, stored in the second database 16B,
measured data 126 for the representative variable of energy consumption, delivered by each measuring element 31.
   Advantageously, the parameters as a function of which the command instructions 36 are generated shall also include the signal 112 for the detection of the presence of a user within the premises 18. The calculation module 108 is therefore designed to adapt the temperature setpoints, i.e. the time scheduling data, on each thermal control device 10, depending upon whether the signal 112 indicates the presence or absence of a user within the premises 18. This permits the reduction of unnecessary energy consumption by the devices 10. More specifically, the calculation module 108 is designed to:
maintain the calculated time scheduling data in force for such time as the signal 112 indicates a presence; and
where the signal 112 indicates an absence, and under certain conditions, modify the time scheduling data for a switchover to “economy” mode.

The data element 114 is, for example, transmitted to the server 24 via the communication network 17, as detailed hereinafter.

According to a preferred form of embodiment, the calculation module 108 is moreover designed to generate, for each thermal control device 10, from the temperature data 116 measured by the associated temperature sensor 28, seasonal climatic or temperature data 118 and representative data 120 for technical characteristics of the premises, a first estimated data element 122 which is representative of the energy consumption by the device 10 and a second estimated data element 123 which is representative of an energy saving realized. The calculation module 108 is moreover designed to generate, for each thermal control device 10, a calibrated data element 124 which is representative of an energy saving realized. The value of the calibrated data element 124 corresponds to the value of the second estimated data element 123, staggered in relation to the margin between the value of the first estimated data element 122 and the value of the measured data 126 for the representative variable of energy consumption delivered by the associated measuring element 31. The measurement of the representative variable of energy consumption and the calculation of the calibrated data element 124 which is representative of an energy saving realized provide a user with real-time information on the energy consumption of the thermal control devices 10 and/or on the level of savings realized, as described hereinafter.

According to a specific exemplary embodiment, the calculation module 108 is moreover designed to simulate the annual cost of a number of scenarios for the time scheduling of temperature, and to determine the scenario which will permit the achievement of the lowest cost. Simulations are executed by the processing, for example, of representative data 120 for technical characteristics of the premises 18, a historic record of seasonal temperature data 118, and offers for available energy supplies on the market. The offer which permits the achievement of the lowest energy bill can thus be identified and advantagesously associated with the calibrated data element 124 which is representative of an energy saving realized, for subsequent presentation to a user.

As a variant or additionally, the calculation module 108 is designed to recommend a modification to the subscribed electric load demand of the user in their current electricity supply offer. More specifically, the calculation module 108 is designed, via the current sensors 31, to obtain real-time measured data 114 for the electric consumption of all the thermal control devices 10, to isolate from these data 114 those which measure a peak in consumption corresponding to a given period, typically in the winter season, and to verify whether this peak in consumption would be compatible or otherwise with an electric load demand which is lower than that subscribed by the user. If this compatibility is confirmed, the calculation module 108 can advantageously propose that the user switch their current electricity supply offer to an offer with a lower electric load demand. This automatic load-shedding operation permits an increase in the level of budgetary savings realized without compromising the comfort of the user and without jeopardizing the electrical installation of the facility.

As a variant or additionally, the calculation module 108 is designed to exploit, in the current electricity supply offer of the user, those time intervals which are subject to a lower tariff, also described as “off-peak hours”. For example, for each switchover to “comfort” mode anticipated in the time scheduling for the temperature of a thermal control device 10, the calculation module 108 is designed to determine whether or not it is cost-effective to supply the device 10 a little earlier, in order to benefit from “off-peak” hours, and thereafter to maintain the power supply to the device until the time of switchover to “comfort” mode initially scheduled. Where applicable, the calculation module 108 is moreover designed to transmit to the electronic console 26, prior to the initially-scheduled commencement of “comfort” mode, a corresponding electric power supply command instruction. This permits an increase in the level of budgetary savings achieved, without compromising the comfort of the user.

In the exemplary embodiment shown in FIG. 6, the generation module 110 is designed to generate the presence detection signal 112 as a function of at least the acoustic data 130 measured by each acoustic sensor 32, and the signal 101 for the detection of the opening of an opening element. More specifically, the generation module 110 is designed to calculate, from the measured acoustic data amplified by the amplifier 94 on each acoustic sensor 32, an average acoustic energy value over a predetermined duration. This calculation of an average acoustic energy value is executed, for example, on a daily basis, wherein the predetermined duration is equal, for example, to one hour. The generation module 110 is also designed to calculate the average minimum ambient noise in an iterative manner. This average minimum ambient noise is obtained by the averaging of each new average acoustic energy value calculated with a historic mean of the average acoustic energy values previously calculated. This calculation of the average minimum ambient noise is executed, for example, on a daily basis. The generation module 110 is moreover designed to undertake the periodic comparison of each measured acoustic data element, filtered by the filter 96 of one of the acoustic sensors 32, with the average minimum ambient noise, and to generate the presence detection signal 112 as a function of the result of this comparison. More specifically, the result of this comparison may be the detection of a human noise, and the generation module 110 is designed to generate the presence detection signal 112 in response to each human noise detected.

More specifically again, the generation module 110 is designed to assign to each filtered acoustic data element measured an indicative data element for the proportion of time during which sounds have been detected, relative to the total duration of measurement. For example, the generation module 110 is designed to assign to each filtered acoustic data element measured a data element from the group comprised of the following: a first indicative data element of a proportion of time equal to 10%, a second indicative data element of a proportion of time equal to 50%, and a third indicative data element of a proportion of time equal to 90%. Upon the comparison of each filtered acoustic data element measured with average minimum ambient noise:
if the indicative data element associated with the filtered acoustic data element measured is the third data element, indicative of a proportion of time equal to 90%, and the measured value of the filtered acoustic data element exceeds the value of the average minimum ambient noise, a human noise is detected;
if the indicative data element associated with the filtered acoustic data element measured is the second data element, indicative of a proportion of time equal to 50%, and the measured value of the filtered acoustic data element exceeds the value of the average minimum ambient noise, a difference in acoustic intensity between the two values is calculated:
   if the difference in acoustic intensity is equal to or greater than 20 dB, a human noise is detected;
if the indicative data element associated with the filtered acoustic data element measured is the first data element, indicative of a proportion of time equal to 10%, and the measured value of the filtered acoustic data element exceeds the value of the average minimum ambient noise, a difference in acoustic intensity between the two values is calculated:
   if the difference in acoustic intensity is equal to or greater than 65 dB, a human noise is detected.
      In all other cases, no human noise is detected.

The generation module 110 is also designed to generate the presence detection signal 112 upon the reception of the signal 101 of the detection of the opening of an opening element.

The computer 14 is connected to the control unit 12 via the communication network 17. The computer 14 is provided with data acquisition means 132. In the exemplary embodiment shown in FIG. 1, the computer 14 is a wireless communication device, such as a smartphone or a digital tablet computer, and the acquisition means 132 comprise a user interface 134 and an application 136 stored in a memory 138 of the computer 14. In an unrepresented variant, the computer 14 is a desktop computer or a portable computer, and the acquisition means 132 comprise an interface for accessing the Internet.

The user interface 134 is, for example, a touchscreen. The interface 134 specifically permits the display of at least one button for the setting of a temperature which is classified as the “comfort” mode temperature, and a temperature which is classified as the “economy” mode temperature. In a particular form of embodiment, the interface 134 may also display buttons for the setting of time schedules for temperature required by the user and/or a shutdown button for all the thermal control devices 10. Further to the activation of one of these buttons by the user, the computer 14 is designed to transmit a corresponding command signal to the server 24. This real-time transmission, in combination with real-time communication between the server 24 and the electronic console 26, permits the rapid incorporatioon of a user instruction, which is preferably implemented within a time interval equal to less than 5 seconds. Advantageously, the interface 134 permits the display, for each room in the premises 18, of a button for the setting of time schedules for temperature required and/or a shutdown button for the thermal control devices 10 in said room. This permits the fine control of the required temperature in each room of the premises 18. Advantageously again, the interface 134 permits the display of a field for the entry of textual data which are indicative of technical characteristics of the premises 18. The computer 14 is then able to transmit these data to the second database 16B, via the communication network 17. Advangtageously again, the interface 134 permits the display of the representative calibrated data element 124 for an energy saving and/or the first representative estimated data element 122 for the energy consumption of the device 10. The user is thus able to identify, in real time, the energy consumption of the thermal control devices 10 and/or the level of savings realized.

The application 136 is, for example, downloadable from the communication network 17. The application 136 comprises a module for the acquisition of representative data on user interactions with the premises 18. Such data can represent, for example, the presence or absence of the user in the premises 18. In this case, the interface 134 permits the display of buttons for the selection of a “present” mode or an “absent” mode. Such data can also indicate information on the opening of an opening element 34 by the user. In this case, the interface 134 permits the display of an indicator button for the opening of an opening element.

As a variant or additionally, the application 136 comprises a module for the acquisition of representative data on thermal sensations of a user within the premises 18. In this case, the interface 134 permits, for example, the display of buttons for the selection of a “cold” thermal sensation or a “hot” thermal sensation, corresponding to the thermal sensation of the user.

As a variant or additionally, the application 136 comprises a geolocation module which is designed to acquire data on the geographical position of the computer 14, for example, satellite data of the GPS type (GPS=Global Positioning System).

The user interface 134, or the web access interface in the case of a desktop computer or portable computer, are also designed to receive alerts generated by the application 26 on the server 24, and to deliver a visual representation of these alerts. The alerts are, for example, e-mail notifications or “push” notifications in the case of a wireless communication device. According to a specific exemplary embodiment, these alert functions comprise one or more buttons which permit a user, further to the selection of the button on the interface, to respond to information in real time. This permits an increase in the interactivity of the system. For example, if the device 33 detects the opening of the opening element 34, the server 24 transmits to the console 26 a command instruction for the shutdown of the thermal control devices 10. In practice, in this case, the opening of the opening element 34 may cause substantial thermal losses, resulting in unnecessary energy consumption. An alert is thus transmitted by the server 24 to the user via the interface 134 or via the web access interface. This alert indicates an opening of the opening element 34, and includes a button which permits the user to indicate whether they have closed the opening element 34. If the user indicates that they have closed the opening element 34, the time schedule for the temperature of the thermal control devices 10 is resumed on the associated control devices 30. Otherwise, the devices 10 will remain turned off, until such time as the acoustic detectors 32 detect a reduction in the sound level. The server 24 then transmits to the console 26 an instruction for the restarting of the thermal control devices 10 in accordance with the time schedule in force prior to the interruption in supply, and the intensity of current consumed is measured by the current sensors 31. The restarting function will be maintained in force if the current intensity value measured is equal to or lower than that measured at the time of detection of the opening of the opening element 34. The interactive alert transmitted for the attention of the user will then be replaced by an informative alert. Another example of an alert is the sending of an interactive alert to the user on the day before a public holiday, on Christmas or New Year's Eve, or the day before the start of the school holidays, if the user has children. In this case, the alert incorporates a button which, for example, permits the user to indicate if they will be absent on the following day and, if so, to indicate the duration of their scheduled absence.

Advantageously, the server 24 is designed, via the generation module 110 of the application 106, to generate the presence detection signal 112 as a function, in addition to the acoustic data 130 measured by each acoustic sensor 32 and the signal 101 for the detection of the opening of an opening element, of data acquired and/or geolocated by the computer 14.

Advantageously, the calculation module 108 is designed for the deduction, from data acquired and/or geolocated by the computer 14, of “logical” sequences for the presence and absence of a user over a given period of time (for example, if a user indicates, via the interface 134, a “cold” thermal sensation on the same day at an interval of one week, the calculation module 108 will deduce a potential requirement for the adjustment of the time schedule such that the user will no longer feel cold on the same day in subsequent weeks, and transmits a message to the application 106 of the computer 14 to alert the user, and establish whether the latter actually wishes to modify the time schedule for this day of the week, or whether the indication of the relevant thermal sensation was exceptional. If the user accepts the proposal, the calculation module 108 is designed to apply the new time schedule).

The server 24 is moreover designed to generate command instructions 36 for each thermal control device 10, as a function of parameters comprising, moreover, data acquired by the computer 14. Data acquired by the computer 14 comprise at least a indicative data element 114 for a restriction of energy consumption. For example, this data element 114 may take the form of a numerical data element which is representative of a monthly or annual energy budget which is not to be exceeded. As a variant, this data element 114 may take the form of a quantified target for budgetary savings to be realized. In both cases, the interface 134 permits the display of a field for the entry of a numerical data element by a user. As a further variant, the user enters no numerical data in the interface 134, and the data element 114 assumes an “infinite” value, indicating that no restriction on energy consumption is imposed by the control unit 12. In this case, the calculation module 108 of the server 24 determines and allots, for each control device 30, and energy quota having an “infinite” value.

In practice, further to the entry thereof by the user in the interface 134, the data element 114 is transmitted by the computer 14 to the server 24 via the communication network 17, and the calculation module 108 of the application 106 determines the energy consumption setpoint for each thermal control device 10 as a function of the value of this data element 114, a history of temperature data 116 measured within the premises 18, a history of seasonal climatic or temperature data 118, and a history of data 122 representative for energy consumption. The calculation module 108 also determines the temperature setpoint on each thermal control device 10, and command instructions 36 are then transmitted by the server 24 to the electronic console 26, for deployment by the control devices 30. Each measuring element 31 measures a representative variable of energy consumption, typically the intensity of an electric current, and delivers measured data 126 to the server 24. As each measuring element 31 is arranged within a control device 30, each control device 30 is thus able to verify, in the course of the application of the temperature setpoint, that the energy quota allotted by the energy consumption setpoint is not exceeded by the measured value of the representative variable for energy consumption. If, on each control device 30, the measured value achieves a predetermined percentage of the allotted energy quota, for example a percentage substantially equal to 90%, the control devices 30 notify the server 24, and the server 24 transmits to the console 26 a command instruction for the shutdown of certain thermal control devices 10, in a predetermined order. For example, priority may be assigned to the device 10 situated in a “living” room, during the daytime. This permits the continuous regulation of the thermal comfort of the user as a function of energy consumption, and the adjustment of periods of comfort in accordance with strict necessity.

Advantageously, the generation module 110 is also designed to generate the presence detection signal 112 upon the reception of data on the geographical position of the computer 14, acquired by the computer 14 and then transmitted to the server 24, indicating that the computer 14 is situated on the interior of the premises 18. Further advantageously, the generation module 110 is designed to generate the presence detection signal 112 upon the reception of representative data for the thermal sensations of a user within the premises 18, or data indicating an opening of the opening element 34 by the user, or data indicating a modification to the time schedule for temperature required by the user, wherein said data are acquired by the computer 14, then transmitted to the server 24.

Advantageously, the generation module 110 is also designed to generate an absence signal if:
it receives, from the computer 14, data which are indicative of the absence of the user from the premises 18; or
it receives, from the computer 14, data on the geographical position of the computer 14 indicating that the computer 14 is situated on the exterior of the premises 18; or
it receives, from the computer 14, a positive response from a user to an interactive alert which permits the latter to indicate whether they will be absent on the following day; or
over a predetermined duration, it receives, from the computer 14, no representative data for interactions of the user with the premises 18, and no data indicating a modification to the time schedule for the desired temperature and, over this same predetermined period, detects no human noise within the premises 18.

It will thus be understood that the control apparatus 22 according to the invention permits the further reduction of the energy consumption of each thermal control device 10, without affecting the ultimate thermal comfort of the user. Moreover, the control system 1 according to the invention permits, by the deployment of concentric “intelligent” blocks formed by the network of devices 30 for the control of the thermal control system, by the electronic console 26, by the server 24 and by the computer 14, the achievement of a further increase in the reduction of the overall level of energy consumption, and thus in the level of budgetary savings realized.

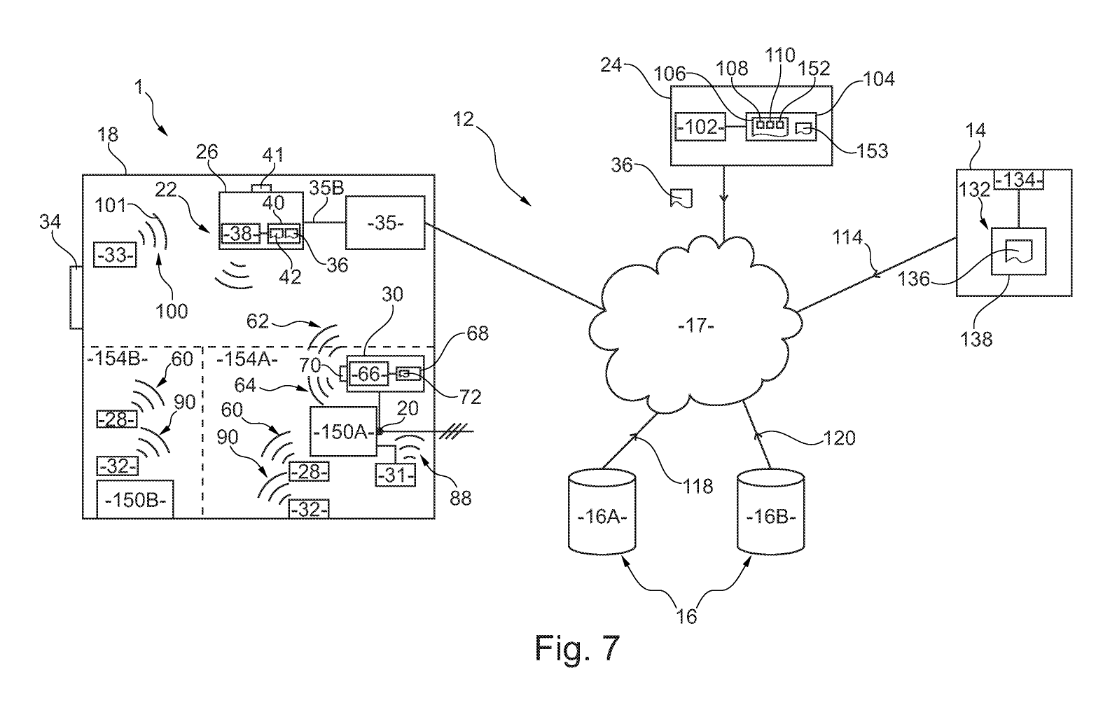

FIG. 7 illustrates a variant of embodiment of the invention, the analogous elements of which to the first exemplary embodiment, described heretofore with reference to FIGS. 1 to 6, are identified by identical reference numbers, and are thus not described again.

In this variant of embodiment, two thermal control devices 150A, 150B are represented. A first thermal control device 150A comprises an electric power supply input terminal 20 which is designed for connection to an electric power supply source. The first thermal control device 150A is, for example, a gas boiler, which supplies a second thermal control device 150B, for example a thermal radiator, via the circulation of hot water. According to this variant of embodiment of the invention, the combination of thermal control devices 150A, 150B forms a central heating system. Each device 150A, 150B is, for example, installed in a room of the premises 18.

The control apparatus 22 comprises an electronic console 26, at least one temperature sensor 28, at least one control device 30 and at least one measuring element 31 for a representative variable of energy consumption. In the specific exemplary embodiment illustrated in FIG. 7, the control apparatus 22 comprises two temperature sensors 28, a control device 30, and a measuring element 31 for a representative variable of energy consumption by the first thermal control device 150A. According to this exemplary embodiment, the control apparatus 22 moreover comprises two acoustic sensors 32 and a device 33 for the detection of the opening of an opening element 34.

According to the variant of embodiment shown in FIG. 7, the module 46 for the management of an autonomous mode of the electronic console 36, present within the application 42, is designed to transmit to the storage module 50, for storage in the memory 40, data for the time scheduling of temperature in each zone of the premises 18, and data on the allotted energy quota, as detailed hereinafter. According to this variant of embodiment, the management module 46 comprises a correspondence table between the various zones of the premises 18 and data for the time scheduling of temperature.

Each temperature sensor 28 is arranged on the exterior of the control device 30, for example in a room of the premises 18. The first and second data links 60, 62 are separate. According to a preferred form of embodiment, the control device 30 is designed to communicate with each temperature sensor 28 via a third data link 64.

The control device 30 is arranged within the premises 18, and is connected to the electric power supply input terminal 20 of the first thermal control device 150A. The control device 30 is designed to control the electric power supply on the first thermal control device 150A, for example via the control of an internal electronic power supply control circuit on the first device 150A.

The measuring element 31 is arranged on the exterior of the control device 30, and is connected to the first thermal control device 150A. The measuring element 31 is designed to measure a representative variable of energy consumption by the first thermal control device 150A. In the exemplary embodiment shown in FIG. 7, the measuring element 31 is a flow sensor for the gas delivered by the gas boiler 150A. The second and fourth data links 62, 88 are separate. The measuring element 31 is designed to transmit measured data for the variable on the fourth data link 88, and to transmit said measured data to the control device 30 via the third data link 64.

In the preferred exemplary embodiment shown in FIG. 7, the third data link 64 and the fourth data link 88 are each configured as a wireless radioelectric link, for example a radioelectric link in compliance with IEEE standard 802.15.4 (Zigbee protocol), or a radioelectric link employing a frequency band which substantially encompasses a central frequency equal to 868 MHz.

Each acoustic sensor 32 is arranged on the exterior of the control device 30, for example in a room of the premises 18. The second and fifth data links 62, 90 are separate. Each fifth data link 90 is a wired link or a wireless link. In a preferred form of embodiment illustrated in FIG. 7, each fifth data link 90 is a wireless radioelectric link, for example a radioelectric link in compliance with IEEE standard 802.15.4 (Zigbee protocol), or a radioelectric link employing a frequency band which substantially encompasses a central frequency equal to 868 MHz.

The application 106 of the server 24 comprises, in addition to the calculation module 108 and the module 110 for the generation of a signal 112 for the detection of the presence of a user in the premises 18, a zoning module 152. The memory 104 of the server 24 moreover comprises a decision-making table 153.

According to the variant of embodiment illustrated in FIG. 7, the calculation module 108 is no longer designed to generate, for each thermal control device 150A, 150B, a representative calibrated data element 124 for an energy saving realized. In practice, the measured data 126 represent only the energy consumption of the first thermal control device 150A, and the calculation module 108 is only designed to generate a first representative estimated data element 122 for the overall energy consumption of the combination of the thermal control devices 150A, 150B, and a second representative estimated data element 123 for the overall energy saving realized.

The zoning module 152 is designed to divide the premises 18 into a number of predetermined zones, wherein each zone comprises at least one temperature sensor 28. In the exemplary embodiment shown in FIG. 7, the zoning module 152 is designed to divide the premises 18 into two predetermined zones 154A, 154B, wherein each zone 154A, 154B comprises a temperature sensor 28. A first zone 154A corresponds, for example, to a living room, and a second zone 154B corresponds, for example, to a bedroom. The zoning module 152 is designed to generate a correspondence table between the various zones 154A, 154B of the premises 18 and the scheduling data for temperature, and to transmit this table to the electronic console 26, via the communication network 17.

The inputs of the decision-making table 153 are the time scheduling data for temperature in each predetermined zone 154A, 154B, wherein said data are delivered by the calculation module 108. The output of the decision-making table 153 is a command signal for the priority execution of the time schedule in one of the predetermined zones 154A, 154B. The priority execution command signal is designed for transmission to the control apparatus 22 via the communication network 17, and is determined by the deployment of a decision-making algorithm. The decision-making algorithm of this type is given, for example, by the following sequence:
if, during a previous period of predetermined duration, for example of a duration substantially equal to one hour, a user has indicated, via the interface 134, a “cold” thermal sensation in one of the zones 154A, 154B of the premises 18, said zone will be adopted as a priority zone for the “comfort” mode;
if, during a previous period of predetermined duration, for example of a duration substantially equal to one hour, a user has indicated, via the interface 134, a “hot” thermal sensation in one of the zones 154A, 154B of the premises 18, said zone will be adopted as a priority zone for the “economy” mode;
if, during a previous period of predetermined duration, for example of a duration substantially equal to one hour, no user has interacted with the interface 134, a verification of the time schedule for the combination of the predetermined zones 154A, 1548 is executed, common time slots for the “comfort” mode shared by at least two of the predetermined zones are identified, and prioritization is applied as follows:
   if a time slot shared by three zones is identified, priority is assigned to the “bathroom” zone,
   if a time slot shared by two zones, including the “bathroom” zone is identified, priority is assigned to the “bathroom” zone;
   if a time slot shared by two zones, excluding the “bathroom” zone, is identified, priority is assigned as a function of the time of day and the users of the premises 18. For example, for a family with children, between 00:00 a.m. and 9:00 a.m., priority is assigned to the “bedroom” zone, between 9:00 a.m. and 7:00 p.m., priority is assigned to the “living room” zone, and between 7:00 p.m. and 00:00 a.m. priority is assigned to the “bedroom” zone;
   outside the shared “comfort” mode time slot, the priority execution command signal will assign priority to the zone in “comfort” mode, where applicable, and
   when all the zones are in “economy” mode, priority is systematically assigned to the “bedroom” zone.

Advantageously, the zoning module 152, in association with the decision-making table 153, permits the effective resolution of the issue of the excessively hot or excessively cold room in a centralized thermal control system of the type represented in FIG. 7.

As the remainder of the operation of the control system according to the variant of embodiment illustrated in FIG. 7 is similar to that of the control system according to the first mode of embodiment illustrated in FIGS. 1-6, no further detailed description thereof will be provided here.

It will thus be understood that the control apparatus 22 according to the invention moreover permits the control of both centralized and decentralized thermal control systems.

According to a second aspect of the invention, which is complementary to, but independent of the first aspect, the invention also relates to a device for the detection of the presence of a user in at least one room of the premises 18. The presence detection device comprises at least one acoustic sensor 32 and a server 24, wherein the or each acoustic sensor 32 is arranged within the premises 18. The server 24 is connected to the or each acoustic sensor 32 via a communication network 17. In a specific exemplary embodiment, the or each acoustic sensor 32 is connected to the communication network 17 via an electronic console 26 which is connected to a terminal box 35, wherein the terminal box 35 provides access to a high-capacity data communication link incorporated in the network 17, for example a high-capacity Internet link. The electronic console 26 and the terminal box 35 are, for example, arranged within the premises 18.

According to this specific exemplary embodiment, each acoustic sensor 32 is designed to communicate with the electronic console 26 via a data link 90. Each acoustic sensor 32 is designed to deliver measured acoustic data, and to transmit said data on the data link 90. The electronic console 26 is designed to transmit to the server 24, via the terminal box 35 and the communication network 17, acoustic data measured by each acoustic sensor 32.

Each data link 90 is a wired link or a wireless link. In a preferred form of embodiment, each data link 90 is a wireless radioelectric link, for example a radioelectric link in compliance with IEEE standard 802.15.4 (Zigbee protocol), or a radioelectric link employing a frequency band which substantially encompasses a central frequency equal to 868 MHz.

Each acoustic sensor 32 comprises a microphone 92, an amplifier 94, a filter 96 and a transmitter 98.

The output of the microphone 92 is connected to the input of the amplifier 94. The microphone 92 has a bandwidth substantially within the range of 100 Hz to 3500 Hz. The microphone 92 is, for example, a condenser microphone.

The output of the amplifier 94 is connected to the input of the filter 96 and to the input of the transmitter 98. The amplifier 94 is, for example, a staged amplifier.

The output of the filter 96 is connected to the input of the transmitter 98. The filter 96 is, for example, a band-pass filter having a bandwidth substantially within the range of 100 Hz to 250 Hz.

The server 24 comprises, for example, a processor 102 and a memory 104 connected to the processor 102. The memory 104 stores an application 110 which is designed for deployment by the processor 102. The application 110 is designed, upon the deployment thereof by the processor 102, to generate a signal 112 for the detection of the presence of a user within the premises 18, as a function of the acoustic data measured by each acoustic sensor 32.

More specifically, the application 110 is designed to calculate, from the measured acoustic data amplified by the amplifier 94 on each acoustic sensor 32, an average acoustic energy value over a predetermined time interval. This calculation of an average acoustic energy value may be executed, for example, on a daily basis, wherein the predetermined time interval is equal, for example, to one hour. The application 110 is also designed to calculate the average minimum ambient noise in an iterative manner. This average minimum ambient noise is obtained by the averaging of each new average acoustic energy value calculated with a historic mean of the average acoustic energy values previously calculated. This calculation of the average minimum ambient noise is executed, for example, on a daily basis. The application 110 is moreover designed to undertake the periodic comparison of each measured acoustic data element, filtered by the filter 96 of one of the acoustic sensors 32, with the average minimum ambient noise, and to generate the presence detection signal 112 as a function of the result of this comparison. More specifically, the result of this comparison may be the detection of a human noise, and the application 110 is designed to generate the presence detection signal 112 in response to each human noise detected.

More specifically again, the application 110 is designed to assign to each filtered acoustic data element measured an indicative data element for the proportion of time during which sounds have been detected, relative to the total duration of measurement. For example, the application 110 is designed to assign to each filtered acoustic data element measured a data element from the group comprised of the following: a first indicative data element of a proportion of time equal to 10%, a second indicative data element of a proportion of time equal to 50%, and a third indicative data element of a proportion of time equal to 90%. Upon the comparison of each filtered acoustic data element measured with average minimum ambient noise:
if the indicative data element associated with the filtered acoustic data element measured is the third data element, indicative of a proportion of time equal to 90%, and the measured value of the filtered acoustic data element exceeds the value of the average minimum ambient noise, a human noise is detected;
if the indicative data element associated with the filtered acoustic data element measured is the second data element, indicative of a proportion of time equal to 50%, and the measured value of the filtered acoustic data element exceeds the value of the average minimum ambient noise, a difference in acoustic intensity between the two values is calculated:
   if the difference in acoustic intensity is equal to or greater than 20 dB, a human noise is detected;
if the indicative data element associated with the filtered acoustic data element measured is the first data element, indicative of a proportion of time equal to 10%, and the measured value of the filtered acoustic data element exceeds the value of the average minimum ambient noise, a difference in acoustic intensity between the two values is calculated:
   if the difference in acoustic intensity is equal to or greater than 65 dB, a human noise is detected.
      In all other cases, no human noise is detected.

The presence detection device according to the second aspect of the invention permits the accurate detection of one or more human voice(s) in the premises 18, and the deduction therefrom of the presence of a user, by means of components which are inexpensive to manufacture. The presence detection device according to the second aspect of the invention thus permits the achievement of the effective detection of the presence of a user within the premises 18, whilst reducing costs.

According to a third aspect of the invention, which is complementary to, but independent of the first and second aspects, the invention also relates to a method for the installation within premises 18 of an apparatus 22 for the monitoring of at least one thermal control device 10, 150A, 150B. The control apparatus 22 is that described in the aforementioned form of embodiment, in which the electronic console 26 is equipped with a radio-tag 41, and each control device 30 is equipped with a female connector 61A and a radio-tag 70.

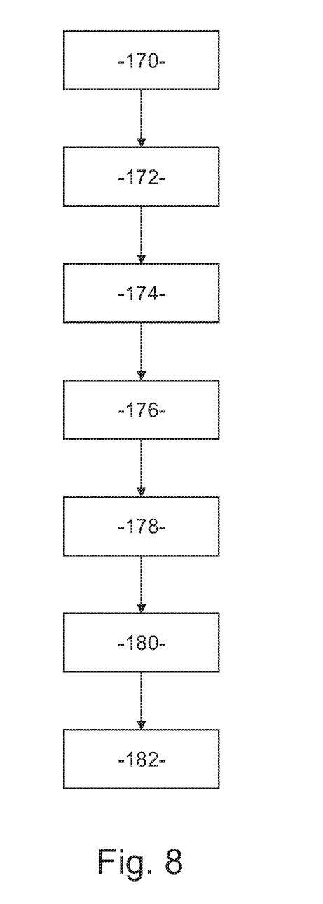

The installation method is illustrated in FIG. 8, and comprises an initial step 170, in which the electronic console 26 is connected to the terminal box 35, using the Ethernet cable 35B. The connection of the electronic console 26 to the terminal box 35 permits the bonding of the console to the communication network 17. Advantageously, the electronic console 26 is electrically powered via a second connection on the terminal box 35, which is in turn connected to an electric power supply source.

Subsequently to, or in tandem with the initial step 170, the electric power supply to the or each thermal control unit 10, 150A is turned off in a step 172, for example by means of an intervention on the electric switchboard of the premises 18.

In a subsequent step 174, each cable connecting an electric power supply input terminal 20 of a thermal control device 10, 150A to an electric power source is physically separated, thus forming two cable strands.

In a subsequent step 176, for each cable separated in step 174, a male plug 61B is connected to the free end of each of the two cable strands.

In a subsequent step 178, an equal number of devices 30 for the control of the electric power supply are provided to the number of control devices 10, 150A to be controlled. Each male plug 61B is then connected to one of the female connectors 61A, such that each device 10, 150A to be controlled is associated with a control device 30. In the first exemplary embodiment illustrated in FIG. 1, during the same step, each control device 30 is arranged below the associated thermal control device 10, for example by the attachment of each control device 30 to a wall of the premises 18, using self-adhesive strips. At the end of this step 178, the electric power supply to the or each thermal control device 10, 150A is restored, for example by means of an intervention on the electric switchboard of the premises 18.

In a subsequent step 180, the radio-tag 41 of the electronic console 26 is scanned, for example using a radio-tag reader device. The reading by the device of the identifier stored in the radio-tag 41 initiates a connection with a server which hosts a web application. The reader device then displays an interface which is linked to the web application and which permits the input of data relating to the premises 18. Data of this type are then entered on the interface of the reader device, thus permitting the pairing of the console 26 with the premises 18.

In a final step 182, the radio-tag 70 of each control device 30 is scanned, for example using a radio-tag reader device. The reading by the device of the identifier stored in each radio-tag 70 initiates a connection with a web server which hosts a web application. The reader device then displays an interface which is linked to the web application, and which permits the input of data relating to the room in which the associated thermal control device 10, 150A is installed, and data relating to the electrical capacity of said device 10, 150A. Data of this type are then entered on the interface of the reader device, thus permitting the pairing of each control device 30 with the console 26. More specifically, the server hosting the web application is, for example, the server 24, and the server 24 is designed to generate the pairing table from the data entered, and to transmit the pairing table thus generated to the electronic console 26. After pairing with the electronic console 26, the control devices 30 are designed to automatically transmit their respective identifiers to the console 26 in order to construct a local network of control devices.

The installation method according to the third aspect of the invention permits the reduction of the installation time for the control apparatus in the premises, and facilitates said installation, in comparison with the installation methods from the prior art.

1. An apparatus for the monitoring of at least one thermal control device that is arranged within premises and includes an electric power supply input terminal which is suitable for connection to an electric power supply source, the apparatus comprising:
an electronic console arranged within the premises, wherein said electronic console stores instructions for the control of the, or of each thermal control device, wherein said control instructions comprise, for each thermal control device, at least one temperature setpoint and one energy consumption setpoint;
at least one temperature sensor arranged within the premises, and designed to communicate with the electronic console via a first data link, wherein the or each sensor is designed to deliver temperature measurement data, and wherein temperature and energy consumption setpoints are determined as a function of parameters which includes at least said temperature measurement data;
at least one electric power supply control device for the thermal control device(s), connected to the electric power supply input terminal of said device, wherein the or each control device is designed to communicate with the electronic console via a second data link, and to deploy the electric power supply command for the device as a function of at least the temperature and energy consumption setpoints transmitted by the electronic console; and
at least one measuring element for a variable which is representative of the energy consumption of the or one of the thermal control device(s), wherein the or each measuring element is arranged within the premises and is designed to communicate with the electronic console (26) via a fourth data link, and wherein the temperature and energy consumption setpoints are determined as a function of parameters which shall include, moreover, measurement data for said variable.

2. The apparatus as claimed in claim 1, characterized wherein the or each control device is designed to communicate with the or one of the temperatures sensor(s) via a third data link, wherein the or each control device is designed to control the electric power supply of the associated thermal control device as a function of at least the temperature and energy consumption setpoints and the measured temperature data delivered by said temperature sensor, for the regulation of temperature within the premises.

3. The apparatus as claimed in claim 1, further comprising at least one acoustic sensor arranged within the premises and which is designed to communicate with the electronic console via a fifth data link, wherein the or each acoustic sensor is designed to deliver measured acoustic data, and wherein the temperature and energy consumption setpoints are determined as a function of parameters which moreover comprise said measured acoustic data.

4. A control unit for at least one thermal control device, wherein the device is arranged within premises and includes an electric power supply input terminal which is suitable for connection to an electric power supply source, the unit comprising:
an apparatus for the monitoring of the or each thermal control device as claimed in claim 1, and
a server, wherein the server is connected to the control apparatus via a communication network wherein the electronic console is suitable for connection to the communication network and is suitable for the transmission to the server of at least the temperature data measured by the or by each temperature sensor, and in that the server is designed to generate command instructions for the or each thermal control device and to transmit said command instructions to the electronic console.

5. The unit as claimed in claim 4, wherein the server comprises at least one processor and at least one memory connected to the processor, wherein the memory stores an application, said application being designed, upon the deployment thereof by said at least one processor, to generate command instructions for the or each thermal control device as a function of parameters which shall comprise at least said measured temperature data.

6. The unit as claimed in claim 5, wherein the application comprises a zoning module which is designed to divide the premises into a number of predetermined zones, in that the control apparatus comprises a plurality of temperature sensors, wherein each predetermined zone is equipped with at least one of said temperature sensors, and in that the memory of the server incorporates a decision-making table, wherein the inputs of said decision-making table are the temperature-related time scheduling data for each predetermined zone, and wherein the output of said decision-making table is a command signal for the priority execution of the time schedule in one of the predetermined zones, wherein the command signal for priority execution is designed for transmission to the control apparatus via the communication network.

7. A computer program product, which is downloadable from a communication network comprising and/or embodied in a computer-readable medium and/or executable by a processor program instructions that constitute the application of the server for the control unit as claimed in claim 5, where the program product is run on said server.

8. The computer program product as claimed in claim 7, further comprising a calculation module which is designed to generate command instructions for the or each thermal control device as a function of parameters which shall include, in addition to the temperature data measured by the or each temperature sensor, indicative data for the restriction of energy consumption, climatic data and representative data for technical characteristics of the premises, wherein the climatic data and representative data for technical characteristics of the premises shall be sourced from at least one database which is connected to the server.

9. The computer program product as claimed in claim 8, wherein the calculation module is designed to generate, for each thermal control device, a first estimated data element which is representative of the energy consumption of said device, and a second estimated data element which is representative of the energy saving realized, wherein said first and second estimated data elements are obtained at least from the temperature data measured by the or each temperature sensor, climatic data, and data which are representative of technical characteristics of the premises, and in that the calculation module is designed to generate, for each thermal control device, a calibrated data element which is representative of the energy saving realized, wherein the value of the calibrated data element corresponds to the value of the second estimated data element, calibrated in relation to the margin between the value of the first estimated data element and the value of the measured data for the variable which is representative of energy consumption.

10. A system for the control of at least one thermal control device, wherein the device is arranged within premises and includes an electric power supply input terminal which is suitable for connection to an electric power supply source, wherein the system comprising:
a control unit for the or each thermal control device as claimed in claim 4,
at least one computer which is connected to the control unit via a communication network, the computer is provided with data acquisition means, wherein the server is designed to generate command instructions for the or each thermal control device as a function of parameters moreover comprising the data acquired by the computer, wherein the data acquired by the computer comprise at least one indicative data element for a restriction on energy consumption.

11. The system as claimed in claim 10, wherein the data acquisition means comprise a user interface and an application stored in the memory of the computer, wherein the application comprises a module for the acquisition of data which are representative of interactions of a user with the premises and/or a module for the acquisition of data which are representative of the thermal sensations of a user and/or a geolocation module, and in that the server is designed to generate a signal for the detection of the presence of a user within the premises, as a function of said acquired and/or geolocated data, and to generate command instructions for the or each thermal control device as a function of parameters which shall moreover comprise said presence detection signal.

12. A computer program product, which is downloadable from a communication network and/or embodied in a computer-readable medium and/or executable by a processor, comprising program instructions that constitute the application for the data acquisition means of the computer of the control system as claimed in claim 11, where the program product is run on said computer.
